(19) United States
(12) Patent Application Publication
(10) Pub. No.: US 2020/0349791 A1
(43) Pub. Date: Nov. 5, 2020

(54) METHOD AND TEST APPARATUS FOR CHECKING THE AUTHENTICITY OF OBJECTS

(71) Applicant: Mühlbauer GmbH & Co. KG, Roding (DE)

(72) Inventors: Ralf Freiberger, Duren (DE); Bertram Burkhardt, Dortmund (DE)

(21) Appl. No.: 16/964,711

(22) PCT Filed: Jan. 24, 2019
(86) PCT No.: PCT/EP2019/051779

§ 371 Date: Jul. 24, 2020

(30) Foreign Application Priority Data
Jan. 26, 2018 (DE) 10 2018 201 204.0

(51) Int. Cl. G07D 5/00; G07D 5/04; G07D 5/08; G01N 23/223; G01N 23/2206; B07C 5/346

(52) U.S. Cl. CPC G07D 5/005; G07D 5/04; G07D 5/08; G07D 2205/00; G01N 23/2206; B07C 5/346; G01N 23/223

(57) ABSTRACT

A method as well as an inspection device are provided for automatically checking the authenticity of objects, such as coins. The method includes carrying out an X-ray fluorescence analysis, XRFA, of an object which is to be checked, and carrying out a first comparison in which one or more properties of at least one fluorescence spectrum generated during the course of the XRFA are compared with an associated first body of reference information; carrying out a second analysis of the object on the basis of a corresponding second inspection method other than XRFA, as well as a second comparison in which an examination result obtained during the course of the second analysis is compared with an associated second body of reference information; and determining an analysis result relating to the authenticity of the object in dependence upon the results of the first comparison as well as the second comparison.

### CROSS-REFERENCE TO RELATED APPLICATION

This application is a national phase entry of, and claims priority to, International Application No. PCT/EP2019/051779, filed Jan. 24, 2019, which claimed priority to German Application No. 10 2018 201 204.0, filed Jan. 26, 2018. The above-mentioned patent applications are incorporated herein by reference in their entireties.

### TECHNICAL FIELD

The present application relates to a method as well as an inspection device for checking the authenticity of objects, such as coins, in an automated manner.

### BACKGROUND

Counterfeiting of valuables, which includes currency coins or other coins with a high value, has been in existence for a long time. In addition, in more recent times, many other kinds of objects, for example many kinds of machinery and equipment or consumer goods, such as for example watches or electronic devices, or components or spare parts thereof, for example spare parts for vehicles or aircraft, have also been counterfeited. The same applies to valuable documents or security documents, such as for example bank notes, identity cards, vouchers and chip cards. Whilst in the past, the recognizing of such forgeries was based almost exclusively on the fact that some human specialists were able to recognize a forgery with a sufficiently high degree of probability by a personal examination of such an object, primarily in a visual and tactile manner or by simple tools or measuring devices, automatic and often complex testing methods and inspection devices are now regularly used for this purpose—not least for reasons of efficiency.

Furthermore, in the case of currency coins which are in circulation, whose effective useful life is naturally limited due to the wear and tear that occurs during their use, there is normally also a need to detect coins which are genuine but damaged, or which are badly soiled or which are otherwise impaired in terms of their usefulness, and to remove them from the cash cycle.

Against this background, methods and inspection devices are known from the state of the art for the automatic, and thus mechanically performed, testing of coins, in which a visual inspection of the respective coin to be tested is carried out by a corresponding inspection device. In this context, the coin is usually illuminated in a predetermined manner and the image which results therefrom is compared with corresponding reference information corresponding to a genuine and undamaged coin in order to obtain a test result regarding the authenticity and/or integrity of the coin. Further, it is known to complement such an automatic visual inspection by an electromagnetic test which uses electromagnetic sensors (EMS), with the aid of which the coins can be checked in terms of their content of certain metal alloys which are present in corresponding genuine coins.

Thus, it would be desirable to further improve the automatic checking of the authenticity of objects, such as that of coins.

### SUMMARY

The desired improvements in the field of authenticating objects is achieved by embodiments of the invention described as follows. A method is provided in one embodiment for automatically checking the authenticity of objects, in particular of coins, such as currency coins, by an inspection device. The method includes: (i) carrying out an X-ray fluorescence analysis, (“XRFA”), of an object which is to be checked, and carrying out a first comparison in which one or more properties of at least one fluorescence spectrum generated during the course of the XRFA are compared with an associated first body of reference information; (ii) carrying out a second analysis of the object on the basis of a corresponding second inspection method other than XRFA, as well as carrying out a second comparison in which an examination result obtained during the course of the second analysis is compared with an associated second body of reference information; and (iii) determining an analysis result relating to the authenticity of the object in dependence upon the results of the first comparison as well as the second comparison.

For the purposes of the invention, an “automatic checking of the authenticity” of an object is to be understood to mean the checking of the object, carried out by an automatic machine in the form of the inspection device, as to whether or not it is authentic. Authenticity here means genuineness in the sense of “found to be original”.

X-ray fluorescence analysis (XRFA), also referred to as X-ray fluorescence spectroscopy (XRFS or XRF spectroscopy) is a method from the field of material analysis on the basis of X-ray fluorescence, in which a material sample, in the present context an object, is excited by X-ray radiation, gamma radiation or ion radiation, whereby energy which is released by subsequent secondary processes is emitted in the form of element-specific fluorescence radiation. This fluorescence radiation can be evaluated by a radiation detector. In principle, the X-ray fluorescence analysis makes it possible to identify, and to determine the concentration of, most chemical elements in a material sample in a wide variety of compositions.

A first “body of reference information” which, in the framework of the invention, is to be compared with a fluorescence spectrum generated by the XRFA is to be understood to mean information or data which is associated with the object to be examined or the corresponding kind of object (or type of object) and which characterizes technical features, or properties resulting therefrom, of an original of that object which are suitable for being used for the purpose of examining the similarity to, or the correspondence with, the fluorescence spectrum generated during the course of the XRFA. The first body of reference information may itself describe a reference fluorescence spectrum or one or more specific characteristic features thereof, such as for example the occurrence, the position (in terms of wavelength or frequency) as well as the amplitude and/or the width of specific maxima or minima of the spectrum.

The second analysis of the object on the basis of a corresponding second inspection method different from the XRFA, such as for example a specific visual inspection or an EMS analysis, thus provides, in addition to the result of the XRFA on the basis of the first comparison, a further analysis result within the framework of the second comparison which does not result from the XRFA, in which second comparison a (second) body of reference information which corresponds to the inspection method correspondingly selected is used in order to check the authenticity of the object. In the case of a visual inspection, this (second) body of reference information can characterize characteristic features of an image of the verified view of an original object, such as for example the spatial position of certain characteristic surface properties, for example embossing of the object, or distributions of brightness, contrast and/or color to be expected under a given illumination, etc. In the EMS analysis, the (second) body of reference data can accordingly describe measured values or measurement curves which are to be expected during the measurement of an original object, with which the EMS measurement results generated during the course of the EMS analysis of an initially unknown object can be compared for the purpose of checking the authenticity.

In contrast to the known authenticity verification methods and devices mentioned above, according to embodiments of the invention, a verification of the object is carried out by at least two different inspection methods, at least one of which uses XRFA to determine a chemical composition of the objects examined. The result of the authenticity check is then determined on the basis of the result of the XRFA analysis as well as on the result of the check with the at least one other, different inspection method. In this way, the overall detection accuracy of the authenticity check can be increased, since also the chemical composition of the object or partial aspects of it can be used for this purpose. In this way, it is possible to detect also those forgeries that would not be detectable on the basis of other inspection methods which have been used to date, or only with considerably greater effort, i.e. for example with a combination of a large number of inspection methods or very complex or destructive analyses, e.g. chemical analyses.

In the following, preferred embodiments of the method will be described, each of which, as far as this is not expressly excluded or technically impossible, can be combined in any desired manner with one another, as well as with the other embodiments of the invention which are described in the following.

In some embodiments, the method further includes: (i) detecting the kind, a condition or at least one predetermined property of the object to be checked; and (ii) carrying out the first and/or the second analysis in dependence upon the result of this detection. In this context, the detection step (i) can be carried out by a sensor device of the inspection device. In these embodiments, a selection and/or adaptation of the inspection methods which are used for the first and/or the second analysis thus takes place as a function of the kind, the condition or at least one predetermined property of the object determined in the detection step (i). This can be used advantageously to automatically select, in dependence thereupon, an optimized set of inspection methods as well as their optimized settings with regard to the object to be examined. In addition, a purely manual selection or setting via a suitable human-machine interface or a combination of both variants is of course also possible. For example, for certain types of coins it may be advantageous to carry out an EMS procedure as a second inspection method in addition to the XRFA, whereas, by way of contrast, a visual inspection may be preferable to an EMS analysis for other types of coins which have a different material composition. Similarly, for example the selection of the energy of the radiation, in particular the excitation energy for the generation of the X-ray radiation for the XRFA (which then has an X-ray spectrum dependent on this), can be made in dependence upon an object type which has previously been detected in the detection step, for example the type of coin (e.g. currency, nominal value, coin generation, etc.). The selection or the setting of the inspection methods to be used can be made by a comparison of the results of the detection step with a database which, in dependence upon the kind, the condition and/or certain properties of originals of the types of object to be examined, can provide, respectively by corresponding data, optimized combinations or settings of corresponding inspection methods which are suitable for this.

In some of these embodiments, the detection of the kind, a condition or at least one predetermined property of the object to be checked is carried out as a sub-process of the first and/or of the second analysis itself. In this way, it is not necessary to provide, independently of the first and the second analysis, one or more yet further detection processes for carrying out the detection step (i) mentioned above so that the complexity of the method as well as that of the corresponding inspection device can be kept low.

In some embodiments, the second inspection method is selected from several available inspection methods in dependence upon the result of the detection. The inspection device is thus set up to carry out different inspection methods, and to take the decision as to which of these inspection methods is to be used as a second analysis in addition to the XRFA, in dependence upon the result of the detection step, at least partially automatically, i.e. in the case of coins, for example, in dependence upon the type of coin detected during the course of this.

In some embodiments, at least one property of the X-ray radiation which is used in the XRFA is instead, or in addition, determined in dependence upon the result of the detection, i.e. the detection step. The property of the X-ray radiation to be determined may relate to its wavelength or frequency (energy) ranges, its intensity and/or the main radiation direction of the X-rays or a combination of at least two of the aforementioned. This can be used to select the radiation energy of the X-ray radiation as a function of the object type detected since, as a rule, in the XRFA, an optimum range of the X-ray radiation in terms of the wavelength or frequency (energy) is to be selected as a function of the chemical elements or compounds to be detected, in order to obtain optimized measurement results. In a similar vein, it is also possible to adjust for example the intensity of the X-ray radiation in dependence upon an expected emission spectrum of the material of the object to be examined, in such a way that the intensities of the spectrum of the generated fluorescence radiation to be detected in a sensor-based manner are adapted to the needs and limitations of the corresponding radiation sensor for recording the spectrum.

In some embodiments, the object is subjected to the XRFA and/or the second analysis only from one spatial side. In the case of a coin, this may correspond to an analysis of only one main side of the coin (for example obverse or reverse). In this context it is possible that either the analysis is carried out in such a way that a predetermined side of the object is analyzed (e.g. in the case of a coin, its obverse side) and the object is spatially arranged or aligned accordingly, or, conversely, that this is not necessary or that there is a restriction only in that any one main side of the object, such as a coin, is analyzed and not, for example, its ring-shaped edge. In this way it is possible to avoid the object having to be moved into different positions relative to the analyzing device during the analysis and/or vice versa, as a result of which the complexity of the inspection device can be kept low and the loss of efficiency associated with such changes in position can be avoided.

By way of contrast, in some other embodiments the object is subjected to the XRFA and/or the second analysis from at least two different sides, in particular from opposite sides. In this way, the quality and the reliability of the authenticity check can be further increased, since properties from more than one side of the object are taken into account in the analysis, and thus a higher level of discrimination for distinguishing between genuine and counterfeit objects can be achieved.

In some embodiments, the method further comprises a selective discharging of the object having been inspected, in dependence upon the analysis result that has been determined regarding the authenticity of the object and/or of at least one of the following aspects detected during the course of the authenticity check: the kind, a condition, or at least one predetermined property of the object. In this way it is possible not only to determine which of the objects having been checked are authentic or not authentic, but also, when the objects are being discharged from the inspection device, to obtain a sorting of the checked objects as a function of the characteristics of the individual objects which have been determined during the course of the checking, in particular their authenticity, kind, condition or other characteristics. In this way, in a simple variant, for example all objects which have been recognized as authentic can be discharged separately from the objects which have been recognized as not authentic. In a somewhat more complex variant, further sorting can also be carried out for at least one of the two cases, for example according to the type of object or a degree of damage or contamination detected during the inspection. In this way, an authenticity check can be combined with a check with regard to any damage and/or soiling of the objects, and the discharging can be carried out in a differentiated manner according to the results of these analyses.

In some embodiments, the second inspection method is one of the following: (i) a visual or an optical inspection; (ii) an inspection by an electromagnetic sensing device, EMS; (iii) a determination of the weight, mass or mass density; (iv) secondary ion mass spectroscopy; or (v) scanning electron microscopy, SEM. The visual or optical inspection may be carried out by image recognition and/or laser inspection.

In accordance with some associated embodiments, the visual or optical inspection comprises irradiating the object with light (a) along, or at least substantially along, a single direction of irradiation, (b) by a light dome, or (c) by a ring illuminator; as well as, in each case, detecting the light which has been reflected from the object. As a rule, all of the above variants result in different lighting conditions, so that the most advantageous one can be selected and used in dependence upon the object to be inspected.

In accordance with some associated embodiments, at least one of the following sub-processes of the authenticity check is carried out by the inspection device in a clock-based manner according to a clock signal: object feed, first analysis, second analysis, object discharge. It is expedient to carry out all of the sub-processes of the authenticity check in this manner according to a clock signal. In this context, the clock can be variably adjusted in dependence upon the type or the condition or other properties of the objects to be inspected, which can be used to minimize the inspection time and thus to optimize efficiency. The clock can thus depend, for example, on the type of the second and, if applicable, further inspection methods, or also on the type of the objects to be examined themselves, since the analysis times which are required for their examination can depend on their type, (and/or their condition or other properties).

In other embodiments, an inspection device is provided for checking the authenticity of objects, in particular of coins, such as for example currency coins, where the inspection device is set up to carry out the method described above. The inspection device may be set up to carry out the method in accordance with one or more of the embodiments of the method in accordance with the invention which are described herein. The features and advantages which have been explained herein with respect to the method in accordance with the invention or its various embodiments also apply accordingly to the inspection device or its corresponding embodiments.

In some embodiments of the inspection device the latter has a modular structure with two or more modules, of which a first module is configured to carry out the XRFA, a second module, which is different therefrom, is configured to carry out the second inspection method, and, if applicable, further modules are each configured to carry out a respective yet further inspection method. Such a modular structure of the inspection device can be advantageous in several respects. For example, it is possible to easily exchange the individual modules for others and thus, in a corresponding manner, to variably adapt the set of inspection methods which are available with the inspection device, which extends the range of different inspection applications for which the inspection device can be used. In addition, in this way, a repair, an adjustment, a calibration, etc. of the individual inspection methods or inspection devices and their being carried out separately without affecting the other inspection methods or inspection devices is made easier or even possible. Finally, the modular structure also makes it possible to simultaneously and variably integrate inspection modules from different manufacturers in the inspection arrangement and to use them for carrying out the checking of the authenticity of objects.

In accordance with some embodiments, the inspection device is set up to simultaneously analyze two or more objects within the framework of the authenticity check. This can be achieved by the inspection device being constructed so as to be multi-track, at least in sections, so that a parallelized feeding, analysis and/or discharging of two or more objects to be checked is possible in a simultaneous manner. In this way a gain in efficiency can be achieved, in particular with regard to throughput, i.e. the number of objects that can be checked per unit of time.

In accordance with some embodiments, the inspection device further comprises a sorting device for selectively discharging the objects analyzed within the framework of the authenticity check, in dependence upon their result and/or at least one of the following aspects which are captured during the course of the authenticity check: the kind, a condition, or at least one predetermined property of the object. The advantages of a facility for the selective discharging have already been explained above with regard to a corresponding embodiment of the method in accordance with the invention.

In accordance with some embodiments, the inspection device comprises a control device which is set up to control an X-ray radiation source used for the XRFA in such a way that at least one property of the X-ray radiation used for the XRFA, in particular its wavelength, frequency or energy and/or intensity or its main radiation direction, can be variably adjusted through this. The advantages of such a solution have also already been explained above in connection with a corresponding embodiment of the method in accordance with the invention.

In accordance with some embodiments, the inspection device also comprises an output device, which may be formed by a human-machine interface and/or a data interface, and which is configured to output one or more results of the first analysis, the second analysis, if applicable one or more further analyses of the object, and/or the authenticity check of the object as a whole. In this way, the test results can, on the one hand, be communicated to a human operator and, on the other hand, be transferred via the data interface to further processes or machines so that they can be used there. In this context it is conceivable, for example, that, by a corresponding device which is located downstream of the authenticity check, an automatic invalidating or destroying of objects which have been recognized as counterfeits and identified as such by the output data is carried out in dependence upon the output test results.

Further advantages, features and possible applications of the present invention become clear from the following detailed description in connection with the figures.

### BRIEF DESCRIPTION OF THE DRAWINGS

The features and advantages of the invention will be appreciated upon reference to the following drawings. The accompanying drawings, which are incorporated in and constitute a part of this specification, illustrate one or more embodiments of the invention and, together with the general description given above and the detailed description given below, explain the one or more embodiments of the invention.

FIG. 1 schematically shows an inspection device in accordance with an embodiment of the present invention.

FIG. 2 is a flow chart illustrating an embodiment of the method in accordance with the present invention.

### DETAILED DESCRIPTION

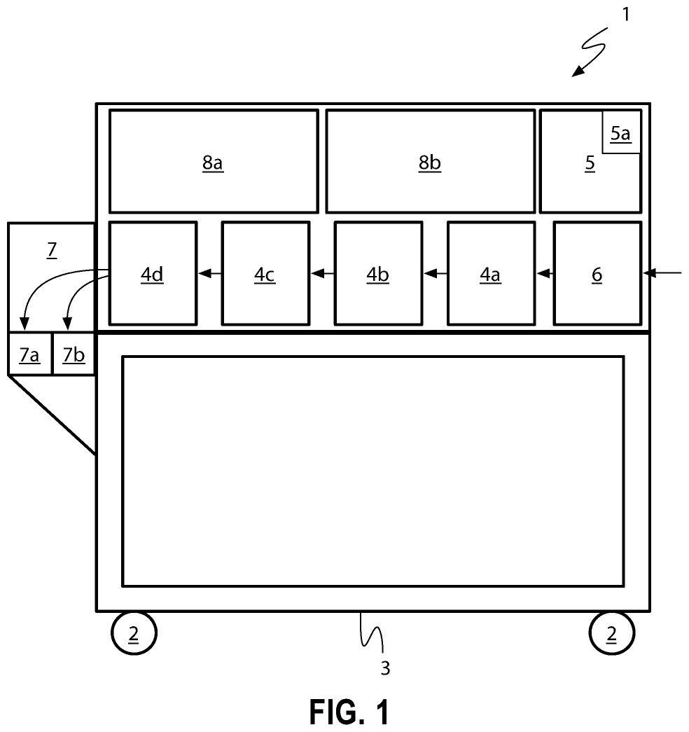

The inspection device 1 shown in FIG. 1, in accordance with an embodiment of the invention, comprises a base in the form of a frame 3, which is mobile on wheels 2. By way of example, four analysis modules 4a to 4d are arranged on the frame 3, each of which is set up to analyze, with regard to an authenticity verification, in accordance with an associated inspection method, objects to be tested, which in the present example are intended to be coins.

The analysis module 4a is set up for visual inspection of the coins, whereby the coins are irradiated by a light dome so that a diffuse reflection of the light on the surface of the irradiated coin is produced and detected for the purpose of the analysis and evaluated. Such an analysis by irradiation using a light dome is especially suitable for the surface and/or color inspection of coins which have already been used.

The analysis module 4b is also set up for the visual inspection of the coins, whereby the coins are however irradiated coaxially, i.e. with parallel light and, at least substantially, perpendicular to that side of the coin which is to be examined, so that accordingly a reflection of the light is produced on the surface of the irradiated coin, which reflection is at least substantially non-diffuse, and is detected for the purpose of analysis and evaluated. Such an analysis is suitable for the surface inspection of coin blanks or of freshly minted, new coins. As an alternative, the analysis module could also use a ring illuminator, which is suitable for the visual inspection of the edge of disc-shaped objects such as coins.

The analysis module 4c is set up to subject the coins to an electromagnetic analysis, EMS, and is accordingly equipped with an EMS sensor system. The EMS analysis can be used to check the coins with regard to any alloys which are contained therein, as these can often be distinguished by their electromagnetic properties.

Finally, the analysis module 4d is set up to examine the coins by an X-ray fluorescence analysis (XRFA), which allows detailed conclusions to be drawn as regards the kind and the concentration of the chemical elements which are contained in the coins, on the basis of which it is possible to distinguish between genuine and counterfeit coins in very many cases.

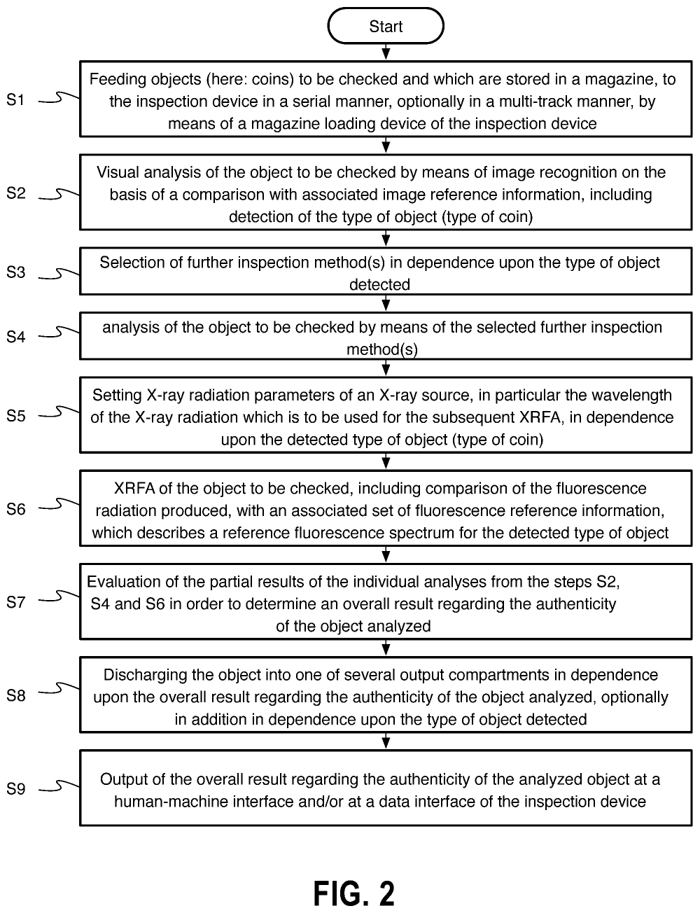

In addition, the inspection device 1 comprises a feeding device 6, which may be constructed as a magazine loading device for receiving one or more coin magazines in which the coins to be tested are inserted in advance. In addition, the inspection device 1 comprises a discharge device 7, which in turn has a plurality of discharge compartments, in the example shown in FIG. 1 the compartments 7a, b, as well as a transport device (not shown) which leads between the feeding device 6 and the discharge device 7 and between them through the various analysis modules. The transport device, which may be formed for example by one or more conveyor belts, serves to convey the coins to be tested through the inspection device 1 along the transport direction, which is indicated in FIG. 1 by arrows. Finally, for its control, the inspection device 1 comprises a control unit 5 which is configured to control the inspection device 1 in a clock-based manner in such a way that the transport device removes the coins to be tested in a serial manner one after the other from the feeding device 6, and feeds them to the analysis modules 4a to 4d (cf. FIG. 2) which have been selected beforehand for carrying out the inspection, as well as finally, by the discharge device 7, selectively deposits, in accordance with the overall result of the respective inspection, the checked coins in a discharge compartment 7a or 7b which is assigned to the respective overall result. Ideally, all of the steps mentioned above should take place according to the specified clock. However, it is also conceivable that this only applies to individual steps and that it is made possible, for example by appropriate object buffers, that individual steps or step sequences of the method are carried out in an asynchronous manner. Finally, the inspection device 1 can further be configured to output the overall result of the inspection, preferably together with partial results of the individual analyses of the analysis modules 4a to 4d which were involved in the inspection, on the monitors 8a and/or 8b serving as human-machine interfaces. As has already been mentioned, an output via a data interface 5a is also possible, which may be constructed on the control unit 5.

FIG. 2 represents a flowchart in order to illustrate an embodiment of the method in accordance with the invention which, for the purpose of better illustration, but without this being intended to be regarded as a restriction, will be explained with reference to the inspection device 1 shown in FIG. 1. The method comprises a step S1 in which objects to be checked and which are stored in a magazine, which in the example discussed here are again intended to be coins, are fed in a serial manner to the first analysis module 4a by the magazine loading device 6. Optionally, several transport and test tracks can also be provided in the inspection device 1 for the simultaneous testing of two or more coins, as a result of which the efficiency of the inspection device 1 or of the method can be increased accordingly, in particular multiplied.

By using the analysis module 4a, a visual analysis of the object to be checked, i.e. of the coin to be checked, is carried out by image recognition on the basis of a comparison with associated image reference information. During the course of this, first of all, the type of coin (generally: the type of object), in particular the currency as well as the nominal value of the coin, is determined and a further visual analysis is carried out with regard to the authenticity of the coin. For this purpose, the coin is illuminated by a light dome with light in the visible part of the electromagnetic spectrum and the resulting diffuse reflection is evaluated by the image recognition and the image reference information assigned to the type of coin that has been recognized. The reference information can be retrieved from a corresponding database, which may be located in the inspection device 1, or however from an external source, such as for example a server, via a communication link. The result of this visual analysis represents a first partial result of the authenticity check of the coin.

In a further step S3, which—like the subsequent step S4—is also optional, it is determined, in dependence upon the type of object or type of coin which has been detected in the step S2, whether and, if so, which of the further inspection methods provided by the inspection device 1 by the further analysis modules 4b to 4d are to be used within the framework of the authenticity check of the coin. For example, during the course of this, it could be determined that, in addition to the visual analysis already carried out by the analysis module 4a, an EMS analysis by the analysis module 4c as well as an XRFA analysis by the analysis module 4d are additionally to be carried out. Accordingly, in the subsequent step S4, the further analysis, in the present example the EMS analysis by the analysis module 4c, is carried out in order to obtain a second partial result of the authenticity check of the coin.

In a further step S5, one or more X-ray radiation parameters of an X-ray source of the XRFA analysis module 4d, in particular the wavelength of the X-ray radiation which is to be used for the XRFA, are then set in dependence upon the detected type of coin. The parameters of the X-ray source are thus adapted to the chemical composition known for the respective type of coin, in such a way that the X-ray radiation is able to, and preferably such that it is optimized to, excite the coin type-dependent fluorescence spectrum required for the XRFA-based inspection of the coin as well as possible when the coin to be inspected is irradiated with the X-ray radiation. In a subsequent step S6 an XRFA examination of the coin to be checked is then carried out by the XRFA analysis module, for which purpose the fluorescence radiation produced is compared with an associated set of fluorescence reference information, which can describe a reference fluorescence spectrum for the detected coin type, in order to obtain a third partial result of the authenticity check of the coin on the basis of this.

In the step S7, which is preferably carried out by the control unit 5, an evaluation of the three partial results of the preceding analyses according to the steps S2, S4 and S6 is carried out in order to determine an overall result regarding the authenticity of the coin which has been analyzed. In the subsequent step S8, the coin is then discharged into one of several output compartments 7a or 7b in dependence upon the overall result, in particular on whether the coin has been recognized as genuine or as a counterfeit, as well as optionally in addition in dependence upon the type of object detected in the step S2. Finally, in a step S9, the overall result regarding the authenticity of the analyzed coin is output at a human-machine interface and/or at the data interface 5a of the inspection device 1. In the case of the inspection device 1 according to FIG. 1, the monitors 8a and/or 8b can represent this human-machine interface. In addition to the overall result, optionally, the partial results of the individual analyses can additionally also be output.

While at least one example embodiment has been described above, it is to be noted that there are a large number of variations to this. It is also to be noted that the example embodiments which have been described only represent non-limiting examples, and that it is not intended to thereby limit the scope, the applicability or the configuration of the devices and methods described here. Rather, the preceding description will provide the skilled person with instructions for the implementation of at least one example embodiment, whereby it is understood that various changes can be made as regards the functionality and the arrangement of the elements described in an example embodiment without deviating from the subject matter respectively defined in the appended claims, as well as its legal equivalents.

What is claimed is:

1. A method for automatically checking an authenticity of objects by an inspection device, wherein the method comprises:
carrying out an X-ray fluorescence analysis, XRFA, of an object which is to be checked, and carrying out a first comparison in which one or more properties of at least one fluorescence spectrum generated during a course of the XRFA are compared with an associated first body of reference information;
carrying out a second analysis of the object on the basis of a corresponding second inspection method other than XRFA, as well as carrying out a second comparison in which an examination result obtained during the course of the second analysis is compared with an associated second body of reference information; and
determining an analysis result relating to the authenticity of the object in dependence upon the first comparison as well as the second comparison, to complete an authenticity check for the object.

2. The method of claim 1, further comprising:
detecting a kind, a condition or at least one predetermined property of the object to be checked; and
carrying out the first or the second analysis in dependence upon the result of this detection.

3. The method of claim 2, wherein the detection of the kind, the condition or the at least one predetermined property of the object to be checked is carried out as a sub-process of the XRFA or of the second analysis.

4. The method of claim 2, wherein the second inspection method is selected from several available inspection methods in dependence upon the result of the detection.

5. The method of claim 2, wherein at least one property of an X-ray radiation which is used in the XRFA is determined in dependence upon the result of the detection.

6. The method of claim 1, wherein the object is subjected to at least one of the XRFA and the second analysis only from one spatial side.

7. The method of claim 1, wherein the object is subjected to at least one of the XRFA and the second analysis from at least two different sides.

8. The method of claim 1, further comprising:
a selective discharging of the object having been inspected, in dependence upon the analysis result that has been determined regarding the authenticity of at least one of the object and of at least one of the following aspects detected during the authenticity check: a kind, a condition, or at least one predetermined property of the object.

9. The method of claim 1, wherein the second inspection method is one of the following:
a visual or an optical inspection;
an inspection by an electromagnetic sensing device, EMS;
a determination of a weight, mass or mass density;
secondary ion mass spectroscopy; and
scanning electron microscopy, SEM.

10. The method of claim 9, wherein the visual or optical inspection comprises irradiating the object with light:
(a) along, or at least substantially along, a single direction of irradiation,
(b) by a light dome, or
(c) by a ring illuminator;
as well as, in each case, detecting the light which has been reflected from the object.

11. The method of claim 1, wherein at least one of the following sub-processes of the authenticity check is performed by the inspection device in a clock-based manner according to a clock signal:
object feed,
first analysis,
second analysis, and
object discharge.

12. An inspection device for checking an authenticity of objects, wherein the inspection device operates to conduct a method comprising:
carrying out an X-ray fluorescence analysis, XRFA, of an object which is to be checked, and carrying out a first comparison in which one or more properties of at least one fluorescence spectrum generated during a course of the XRFA are compared with an associated first body of reference information;
carrying out a second analysis of the object on the basis of a corresponding second inspection method other than XRFA, as well as carrying out a second comparison in which an examination result obtained during the course of the second analysis is compared with an associated second body of reference information; and
determining an analysis result relating to the authenticity of the object in dependence upon the first comparison as well as the second comparison, to complete an authenticity check for the object.

13. The inspection device of claim 12, wherein the inspection device comprises a modular structure with two or more modules, of which a first module is configured to carry out the XRFA, and a second module is configured to carry out the second inspection method.

14. The inspection device of claim 12, wherein the inspection device is set up to simultaneously analyze two or more objects within the framework of the authenticity check.

15. The inspection device of claim 12, further comprising:
a sorting device for selectively discharging objects analyzed within a framework of the authenticity check, in dependence upon at least one of its result and at least one of the following captured during the authenticity check: a kind, a condition, or at least one predetermined property of the object.

16. The inspection device of claim 12, further comprising:
a control device set up to control an X-ray radiation source used for the XRFA in such a way that at least one property of the X-ray radiation used for the XRFA can be variably adjusted.

17. The inspection device of claim 13, wherein the two or more modules of the inspection device further includes further modules that are each configured to carry out a further inspection method beyond the XFRA and the second inspection method.

18. The inspection device of claim 13, wherein the inspection device is set up to simultaneously analyze two or more objects within the framework of the authenticity check, wherein the inspection device further comprises:
a sorting device for selectively discharging objects analyzed within a framework of the authenticity check, in dependence upon at least one of its result and at least one of the following captured during the authenticity check: a kind, a condition, or at least one predetermined property of the object; and
a control device set up to control an X-ray radiation source used for the XRFA in such a way that at least one property of the X-ray radiation used for the XRFA can be variably adjusted,
wherein the two or more modules of the inspection device further includes further modules that are each configured to carry out a further inspection method beyond the XFRA and the second inspection method.

19. The method of claim 3, wherein the second inspection method is selected from several available inspection methods in dependence upon the result of the detection,
wherein at least one property of an X-ray radiation which is used in the XRFA is determined in dependence upon the result of the detection,
wherein the object is subjected to at least one of the XRFA and the second analysis only from one spatial side,
wherein the object is subjected to at least one of the XRFA and the second analysis from at least two different sides,
wherein the method further comprises a selective discharging of the object having been inspected, in dependence upon the analysis result that has been determined regarding the authenticity of at least one of the object and of at least one of the following aspects detected during the authenticity check: the kind, the condition, or the at least one predetermined property of the object,
wherein the second inspection method is one of the following:
a visual or an optical inspection;
an inspection by an electromagnetic sensing device, EMS;
a determination of a weight, mass or mass density;
secondary ion mass spectroscopy; and
scanning electron microscopy, SEM,
wherein the visual or optical inspection comprises irradiating the object with light:
(a) along, or at least substantially along, a single direction of irradiation,
(b) by a light dome, or
(c) by a ring illuminator;
as well as, in each case, detecting the light which has been reflected from the object, and
wherein at least one of the following sub-processes of the authenticity check is performed by the inspection device in a clock-based manner according to a clock signal:
object feed,
first analysis,
second analysis, and
object discharge.
